(19) United States
(12) Patent Application Publication
(10) Pub. No.: US 2002/0029171 A1
(43) Pub. Date: Mar. 7, 2002

(54) Electronic quantity purchasing system

(76) Inventor: Rodney Senior, Fort Myers, FL (US)

Correspondence Address: DOWELL & DOWELL PC, SUITE 309, 1215 JEFFERSON DAVIS HIGHWAY, ARLINGTON, VA, 22202

(21) Appl. No.: 09/805,950

(22) Filed: Mar. 15, 2001

Related U.S. Application Data
(60) Provisional application No. 60/189,472, filed on Mar. 15, 2000.

(51) Int. Cl. G06F 17/60

(52) U.S. Cl. 705/26

(57) ABSTRACT

Disclosed is an electronic quantity purchasing system which is a host computer that a user may access to pre-purchase quantities of goods or services for later redemption. The preferred communication means employed is via secure, high-speed Internet access. Data storage is electronic. Users employ the system to make an instant purchase of a small or large quantity of a commodity, such as gasoline at the current market price. The quantity purchased is credited to the user's account, and the account balance or reserve is established in quantity units (e.g. gallons of fuel). Users can redeem all or part of their balance for real product at a retail location over time. The redemption will draw down the user's account balance. The transaction is carried out in quantity units, so the user is able to circumvent the market price in effect at the time of redemption.

### FIELD OF THE INVENTION

This invention relates to purchasing systems for retail or business goods or services, and in particular to an electronic purchasing system that allows a purchaser to “prebuy” a quantity of goods or services at the current market price, and then take delivery, in whole or in part, at a later time.

### BACKGROUND OF THE INVENTION

There are certain goods and services that consumers frequently purchase that fluctuate in price on a regular basis. These include fuel products; such as, gasoline, diesel, heating oil; food products; and a variety of services. Often the price fluctuations are most noted in commodity items of widespread consumption such as gasoline.

Traditionally, the oil and food industries have provided consumers with a variety of advanced cash deposit schemes to facilitate future purchases of commodities. Some examples are:

a) A prepaid gasoline card (e.g. Mobil, BP, Exxon, Citgo) where consumers pre-pay for a certain value of gasoline e.g. $25.00. This card usually acts as a gift certificate and is usually issued to family members, students or employees in the knowledge that it can be spent only on gasoline.

b) A fuel account at a service station where no credit terms have been agreed. An advanced cash deposit bond is usually required as security.

c) A supermarket Christmas savings club.

d) A pre-paid in-store deposit account providing supermarket customers with a means of controlling their shopping budget and avoid running up a credit bill.

In the above scenarios, when consumers spend their cash deposits on goods, they do so at the market price in effect at the time of redemption. There is currently no method available that allows consumers to redeem at the market price in effect at the time the cash payment was made. This is an important distinction because the price of the goods or services may have moved against the consumer in the meantime and the worth of the pre-paid monetary value deposit will have eroded.

Some purchasing systems have been introduced in certain industry segments in an effort to address some of these issues. Consumers are able to pre-purchase cellular air time in quantity terms not dollar terms. Many plans allow a user to buy a phone card with a certain number of minutes for a set price. Often this pre-purchased air time is in lieu of a monthly plan whereby the user commits to a set monthly fee with a fixed number of minutes being included in the fee. These plans are directed at occasional users or users with very low incomes who are not willing or able to purchase larger quantities or who require the lowest cost entry point. As a result, these plans are typically offered at higher per unit cost than traditional plans. Furthermore, as there is little price fluctuation in the price of these services (cellular air time) the plans are not designed to protect a consumer against price fluctuations by banking or storing the quantity for protection against price volatility.

Thus there is a need for a system which protects consumers' deposits against market price fluctuations and which makes it easy for consumers to pre-purchase fixed quantities of goods or services in advance. This need has heretofore not been met.

In addition to the area of consumer goods and services, there are many goods or services that businesses may wish to pre-purchase for later delivery, in whole or in part. An example of this is:

A fleet manager pre-purchases 5000 gallons of diesel for pick up by his individual truck drivers in 100 gallon quantities at truck stop locations over time. Once ordered, this 5000 gallon full tanker-load of diesel is physically deposited into any tank, with available tank capacity, within the designated truck stop network.

These will-call types of future pick-ups are usually accounted for in monetary value on agreed credit terms or against an advanced monetary down-payment. The physical product itself (diesel) has to be ordered and deposited into the underground tanks, which have a limited capacity. It is administratively cumbersome to pre-arrange for such types of purchases and requires a detailed audit trail, real time tank capacity, readings, and complex billing to handle this type of pre-purchase.

In the above example, there is a need for a system that allows the fleet manager to pre-purchase a ‘full tanker-load’ of diesel at the lowest ‘full tanker-load’ price, lock-in that price, and credit an account held in gallon units. At this point, no physical diesel has actually been delivered but a quantity is held on reserve that can be redeemed in part or in whole. This type of system would allow truck drivers to conveniently draw from a pre-paid gallon reserve account in smaller fill-ups from any truck stop in a large network.

A feature of the system could include seamless integration to proprietary business accounting packages which do not readily provide the facility to hold accounts in quantity units where the pre-purchased units of goods or services are held on reserve.

In general, there is a need for a convenient system which allows both business and consumer purchasers to pre-purchase commodities in larger bulk quantities at discount prices, hold those quantities in a reserve account and redeem, in smaller quantity increments, at convenient points of distribution. In this way, businesses will save money by purchasing large quantities of goods or services at bulk prices whilst operating under the usual practical constraints of redeeming in smaller quantities over time.

There is also a need for businesses supplying many types of goods and services to offer additional means to establish or increase customer loyalty. Without systems to do so, purchasers faced with rapidly changing pricing with respect to standardized goods or services will often purchase from the vendor having the lowest price and will not tend to remain loyal to one brand vendor over another. This is particularly so when dealing with commodities such as gasoline.

### OBJECTS OF THE INVENTION

In particular, an object of the invention is to create an electronic quantity purchasing system with which users may interface in order to purchase and transfer quantities of commodities and then redeem for real product at a future date, at designated locations, in the knowledge that the quantity of commodity so purchased is guaranteed against future market price fluctuations.

An example of this object is:

A consumer pre-purchases 100 gallons of gasoline when pump prices are considered low. The same consumer can redeem the 100 gallons in whole or in part at any one of a network of retail service stations, at a future time, when pump prices are higher. The consumer may also transfer the benefit of the 100 gallons in whole or in part to another user e.g. as a gift or as an expense control measure.

It is a further object of the invention to provide an interface design and interactive database software to allow consumers and businesses to, create a online reserve account, purchase, redeem or transfer quantities of a commodity into and from that account via the electronic quantity purchasing system.

Another object of the invention is to allow users to pre-purchase bulk quantities of commodities at a discounted price and to redeem said quantities in smaller increments at retail locations over time.

It is a further object of the invention to provide businesses will benefit from the significant cost savings made by pre-purchasing in bulk whilst operating under the practical constraints of picking up real product in smaller increments at retail locations. Such constraints could include the size, shape and nature of the commodity or the capacity of the pick-up vehicle.

As an example:

A fleet manager pre-purchases 5000 gallons of diesel at a favorable ‘road tank wagon-full load’ price and deposits the 5000 gallons into his corporate gallon reserve account. The individual truck drivers fill up their vehicles in smaller 100 gallon increments at any convenient site within a national Truck Stop network that has access to the information stored in the electronic quantity purchasing system. The user's gallon reserve account is accessed and the gallon balance is debited online as the truck driver pumps diesel. The fleet manager benefits in three ways:

Purchases diesel at the lowest ‘full road tanker’ rate.

Protects the business against future price fluctuations in diesel.

Substitutes an otherwise convoluted fleet budgeting and accounting system with a simple electronic quantity purchasing system with integrated accounting functionality

Another object of the invention is to provide a mechanism for the pre-purchase of discrete quantities of specific brands of products at an attractive promotional price, with the ability to store and track the quantity purchased until such time as a user wishes to redeem. Redemption is accomplished by users then picking up the real product at locations where there is access to the user's account information stored on the electronic purchasing system. This will save the user money and assist with brand loyalty to a specific product brand for the Vendor.

As an example:

A bar owner pre-purchases 24 bottles of Absolut™ Vodka at a ‘full case’ promotional price. He later picks up 6 bottles at a retail liquor store that has access to his account information. His account of pre-purchased bottles of Absolut Vodka is instantly debited by 6 bottles. The system offers savings to the bar owner by buying the product at the ‘full case’ promotional price, and ensures his loyalty to the Absolut™ brand of vodka which is of benefit to the sponsoring supplier.

A further object of the invention is to provide an electronic quantity purchasing system to provide a mechanism for third party resellers to act as middlemen in the distribution of certain types of goods and services typically subject to price fluctuations. The middlemen could in effect act as bulk purchasers, in turn reselling to end users. This would provide advantages to both the user and the vendor.

### SUMMARY OF THE INVENTION

The present invention relates to an electronic system and methods for purchasing quantities of goods or services in advance at current market prices for later redemption for actual products or services at a distribution location.

An electronic quantity purchasing system is provided that allows users to carry out the pre-purchasing of small or large quantities of a specific good or services, such as gasoline, at a locked-in price, to credit their “quantity units” to a “reserve account.”

The present invention also describes a method of allowing users to transfer quantity units from their electronic quantity purchasing system account, or reserve account, to another user's account.

The present invention also describes a system that allows users to redeem their quantity units in the future for actual products or services at an available point of distribution in order to hedge against future price fluctuations.

The present invention further describes a system that allows purchasers to take advantage of purchasing at bulk prices while preserving the practicality of picking product up at various locations in smaller increments over time.

In one embodiment, the present invention is directed to a method of transacting quantities of a commodity such as gasoline where users access an electronic quantity purchasing system. The method comprises maintaining a computer database system of commodity product information, identifying the quantity units in which quantities of commodity are transacted, identifying the market value for each product for sale and displaying this value in the system catalog, providing each user with a unique secure access code to transact online commodities, branding each commodity for sale with corporate ID to promote the identity of the commodity seller, providing the user with designated actuation controls for instructing the system to instantly purchase the commodity at the posted price of the product, providing the user with designated actuation controls for instructing the system to instantly transfer online commodity to another user, carrying out the transaction by verifying all transaction details, obtaining and recording financial data for automated payment for the online commodity, updating the system database, and instantly reflecting the transaction in the user's account history, and providing the user with a redemption means via a unique identifier, e.g. a bar-coded keytag or magnetic striped & bar coded card, and/or special point-of-sale communications system in order for users to redeem their pre-purchased quantities of commodity at retail locations in the future.

According to a further aspect of the invention, the method includes creating an account for the user or potential user that can take place as part of a pre-registration process. In this way, the registration process can occur on-line or off-line.

According to a further aspect of the invention, the method includes the option of connecting the electronic quantity purchasing system directly to separate and distinct financial institutions for real-time credit approval before a purchase can take place. In this way, instant automated payment confirmation is carried out, as and when required.

According to one embodiment of the present invention, a system for transacting quantities of a commodity online, is provided by a vendor for access by a user (purchaser), which system comprises at least one web server computer designed for serving a host of computer web browsers simultaneously and providing said browsers with the capability to interface with the system, where each browser can carry out a specified transaction of a specified commodity. The web server co-operates with a separate database computer, separated from the web server computer by a firewall. The database computer is accessible to the web computer to allow selective retrieval of commodity information which can include:

Product description

Quantity of product to be transacted

Current market price of the goods or service (commodity) to be purchased

The web server computer can include custom written interface software for transacting commodities in the system database computer by displaying, during a transaction or at any other time, the current price of the commodity, providing a designated user actuation control for instructing the system to instantly purchase a commodity at the posted price, continually updating the price, and continually updating all aspects of the system display as the user uses the interface to interact with the database.

The present invention resolves a complex administrative scheme that would otherwise arise in offering consumers and businesses a means of protecting against future price fluctuations of frequently purchased commodities. It also provides a simple and effective means of allowing purchasers to buy commodities at low bulk prices and then redeem, in whole or in part, at designated locations, at a later time.

### BRIEF DESCRIPTION OF THE DRAWINGS

FIG. 1 is an overview of the system architecture using the Internet as a preferred means of connecting information and system components. Depicted are the major data flow routes, as begun from one of two points, the point of sale terminal or an Internet browser. Electronic Data Transfer, VPN's, or dial-up computer networks can be used as an alternative in areas without web capabilities. In this embodiment a mirrored system is housed at a location discrete from both the Commodity Reserve System, and daily offsite data backup is utilized. Remote access to any part or whole of the system must first be granted authorization via the security measures in place at the firewall.

FIG. 2 is a conceptual map of the possible functions routing from the first data flow point, the point of sale terminal. The User will initiate communication using their personal access device (keytag/card). Again in this embodiment all communications between the point of sale terminal and the machines that make up the complement of the electronic quantity purchasing system are completed via the Internet. A receipt detailing the transaction executed is obtained from the point of sale terminal upon completion.

FIG. 3 is a conceptual map of the possible functions routing from the second, alternative or additional data flow point, an Internet browser. This method of access is location non-specific. The user will initiate communication using standard web browser software on a computer or other Internet-enabled device. Interfacing with the system follows a linear path in a drill-down model, where a system navigation bar contains the designated actuation controls for each functionality path.

FIG. 4 is a graphic example of the personal access device (keytag/card) exercised by the user to activate communications with the system.

FIG. 5 is the display shown after actuating the control to purchase a commodity.

FIG. 6 is the display shown after actuating the control to transfer a commodity to another user.

FIG. 7 is the display shown after actuating the control to view the a detailed breakdown of the user's holdings in the system.

FIG. 8 is the display shown after actuating a control to view all of the commodities and products available in the system catalogue.

FIG. 9 is the display shown after actuating the control to view, in the most detail, the description, image, price and code numbers of a particular commodity or product.

FIG. 10 is the display shown after actuating the control to modify contact info, mailing addresses or access codes on a user's account.

FIG. 11 is the display shown after actuating the control to view the user's entire account history, including all purchases, transfers and redemptions of the quantity units, and details of each transaction. It is displayed in a similar fashion to a bank statement.

### DETAILED DESCRIPTION OF THE PREFERRED EMBODIMENTS

The present invention relates to an electronic system and methods for purchasing quantities of goods or services in advance at current market prices for later redemption for actual products or services at a distribution location.

The purchasing system provides the user with a convenient method of making an advanced purchase of a small or large quantity of commodity via the system at the price posted at the time of the purchase. Purchases are credited to the user's reserve account which is held in quantity units and stored electronically on a host computer. Since the quantity has been pre-purchased at a locked-in price, all commodity reserves in the account are stored in quantity units thus allowing the transaction to circumvent the market price ruling on the day of redemption. The system thus provides a convenient way for the user to hedge against future market price fluctuations of a commodity.

The system includes providing the user with a unique physical identifier e.g. bar-coded keytag or bar-coded and/or magnetic striped card. This identifier, combined with the Point of Sale and related internet-based system architecture and infrastructure, allows the user to redeem all or part of said quantity for real product at a retail location over time. Such a redemption will instantly draw down the user's reserve account balance.

The quantity purchasing system allows a user to transfer to another user some or all of the quantity of commodity purchased. The transferee now assumes ownership of the commodity and can redeem it in the future at retail locations for the quantity of commodity so transferred.

The electronic purchasing system allows users to pre-purchase bulk quantity reserves of commodities at a discounted bulk price and offers pre-purchasing of discrete quantities of specific branded products at the price posted on the system. The system then allows users to redeem real pre-purchased product at retail locations that are connected to the electronically stored information regarding the user. Their online account balance is then instantly debited.

The preferred communication means for the electronic quantity purchasing system is via the Internet thereby providing users with the ability to access their account at home, at work, at the point of purchase, or at any other Internet access location, including wireless access via handheld devices such as PDA's and cellphones.

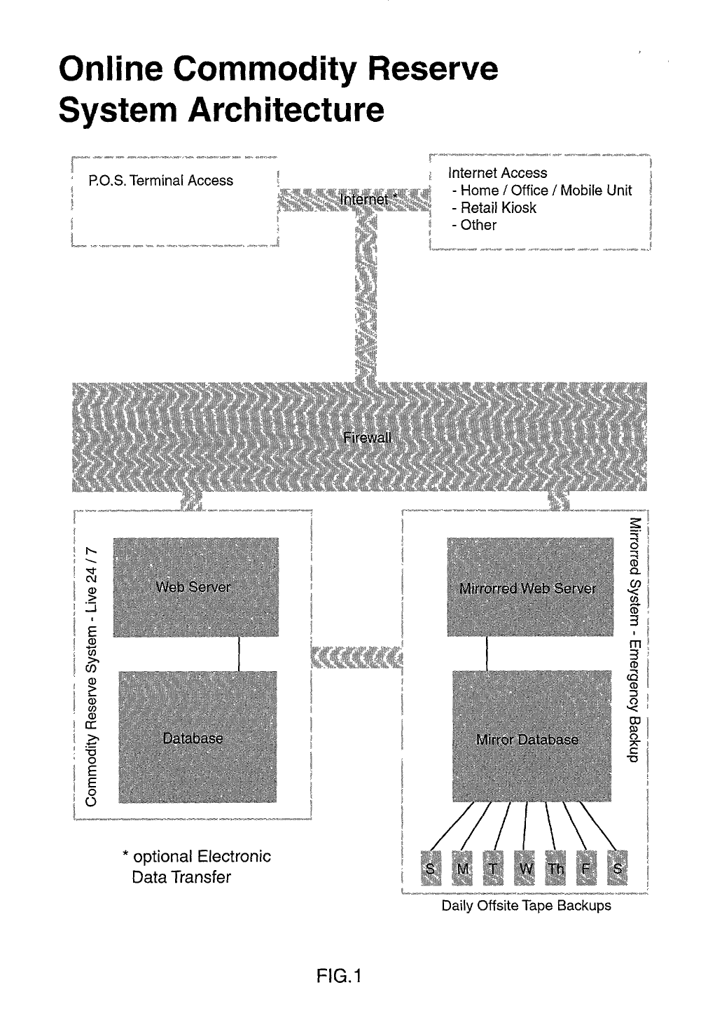

Referring to FIG. 1 an overview of the system architecture using the Internet as a preferred means of connecting information and system components in one embodiment is shown. Depicted are the major data flow routes, as begun from one of two points, the point of sale terminal or an Internet browser. Electronic Data Transfer, VPN's, or dial-up computer networks can be used as an alternative in areas without web capabilities. In this embodiment a mirrored system is housed at a location discrete from both the electronic purchasing system, and daily offsite data backup is utilized. Remote access to any part or whole of the system must first be granted authorization via the security measures in place at the firewall.

The method comprises maintaining a computer database system of commodity product information, identifying the quantity units in which quantities of commodity are transacted, identifying the market value for each product for sale and displaying this value in the system catalog.

Accounts are created for the user or potential user that can take place as part of a pre-registration process. In this way, the registration process can occur on-line or off-line. Each user is assigned a unique secure access code to transact online.

Designated actuation controls are used for instructing the system to instantly purchase the commodity at the posted price of the product. Designated actuation controls are also provided for instructing the system to instantly transfer online commodity to another user.

Optionally the system can brand each commodity for sale with corporate ID to promote the identity of the commodity seller, After a user decides to complete a transaction, transaction details are verified, financial data for automated payment for the online commodity are obtained and recorded, and system database is updated, instantly reflecting the transaction in the user's account history. The method includes the option of connecting the electronic quantity purchasing system directly to separate and distinct financial institutions for real-time credit approval before a purchase can take place. In this way, instant automated payment confirmation is carried out, as and when required.

Users are provided with a redemption means via a unique identifier, e.g. a bar-coded keytag or magnetic striped & bar coded card, and/or special point-of-sale communications system in order for users to redeem their pre-purchased quantities of commodity at retail locations in the future.

The system comprises at least one web server computer designed for serving a host of computer web browsers simultaneously and providing said browsers with the capability to interface with the system, where each browser can carry out a specified transaction of a specified commodity. The web server co-operates with a separate database computer, separated from the web server computer by a firewall. The database computer is accessible to the web computer to allow selective retrieval of commodity information which can include:

Product description

Quantity of product to be transacted

Current market price of the goods or service (commodity) to be purchased

The web server computer can include custom written interface software for transacting commodities in the system database computer by displaying, during a transaction or at any other time, the current price of the commodity, providing a designated user actuation control for instructing the system to instantly purchase a commodity at the posted price, continually updating the price, and continually updating all aspects of the system display as the user uses the interface to interact with the database.

The present invention resolves a complex administrative scheme that would otherwise arise in offering consumers and businesses a means of protecting against future price fluctuations of frequently purchased commodities. It also provides a simple and effective means of allowing purchasers to buy commodities at low bulk prices and then redeem, in whole or in part, at designated locations, at a later time.

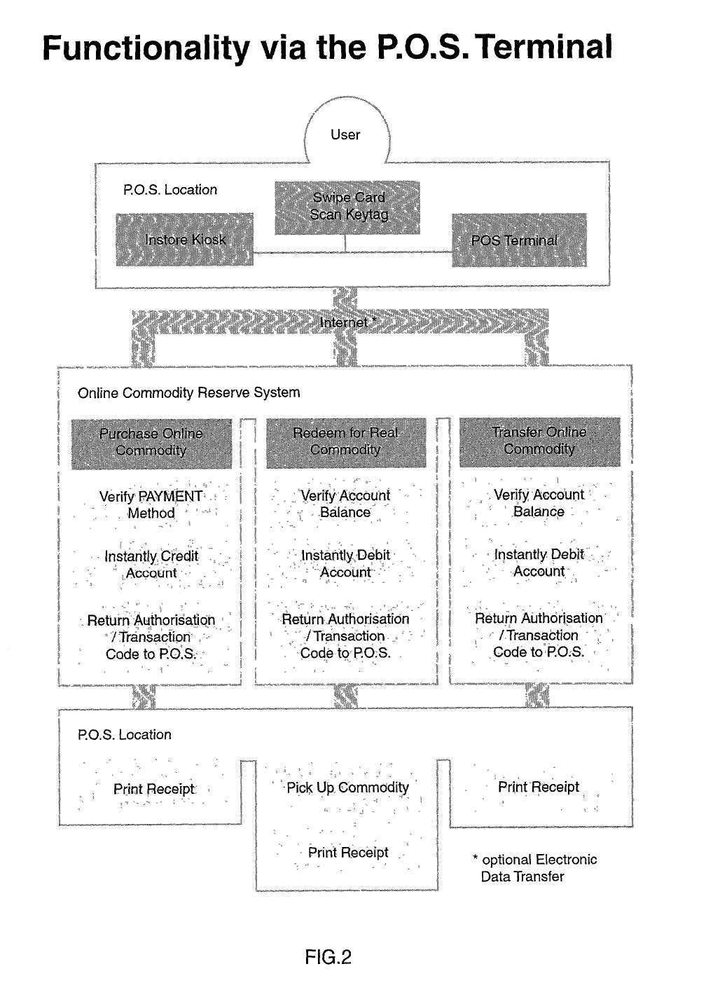

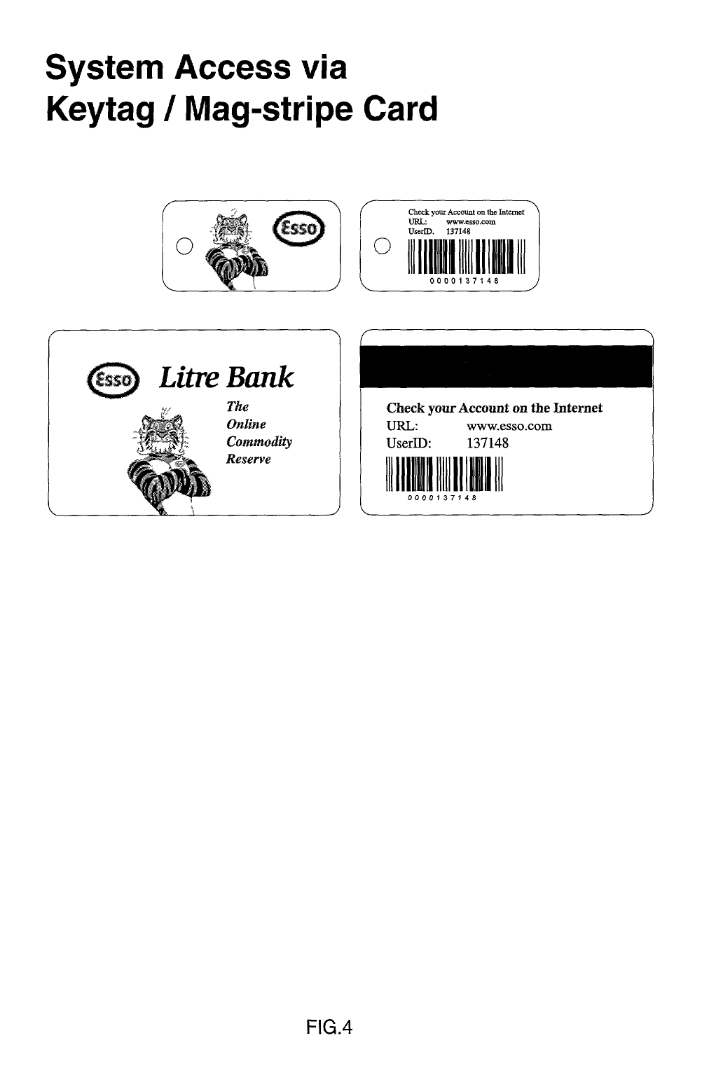

Referring to FIG. 2, communication with the system may be made by a user's personal access device (keytag/card) as depicted in FIG. 4. Again in this embodiment all communications between the point of sale terminal and the machines that make up the complement of the electronic quantity purchasing system are completed via the Internet. A receipt detailing the transaction executed is obtained from the point of sale terminal upon completion.

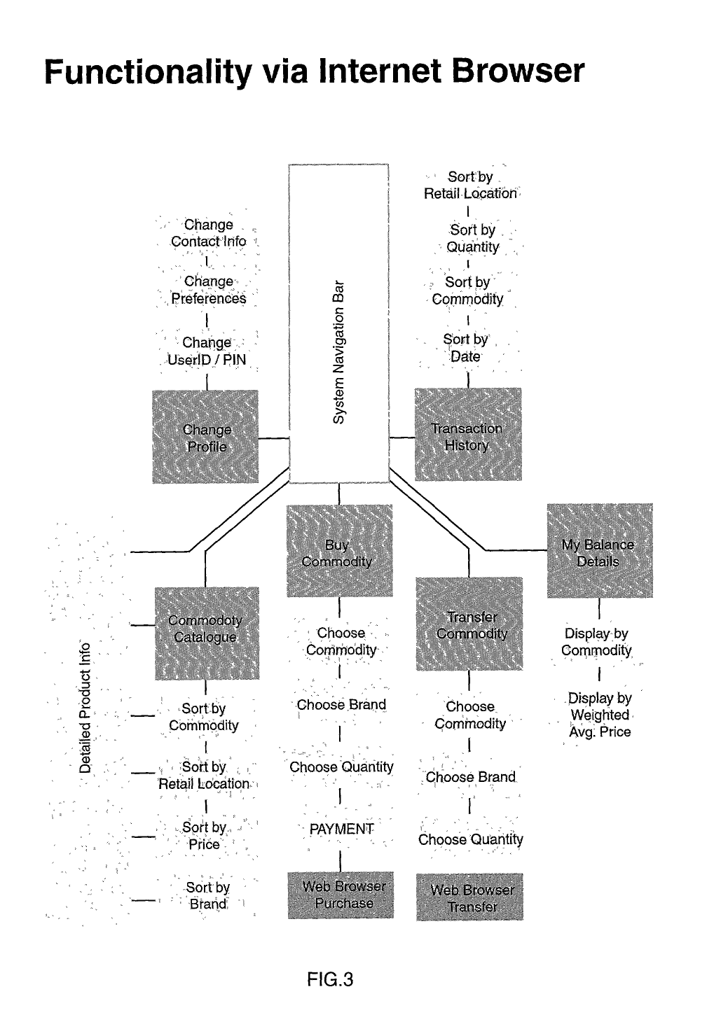

Access can also be obtained by routing from an Internet browser as shown in FIG. 3. This method of access is location non-specific. The user will initiate communication using standard web browser software on a computer or other Internet-enabled device. Interfacing with the system follows a linear path in a drill-down model, where a system navigation bar contains the designated actuation controls for each functionality path.

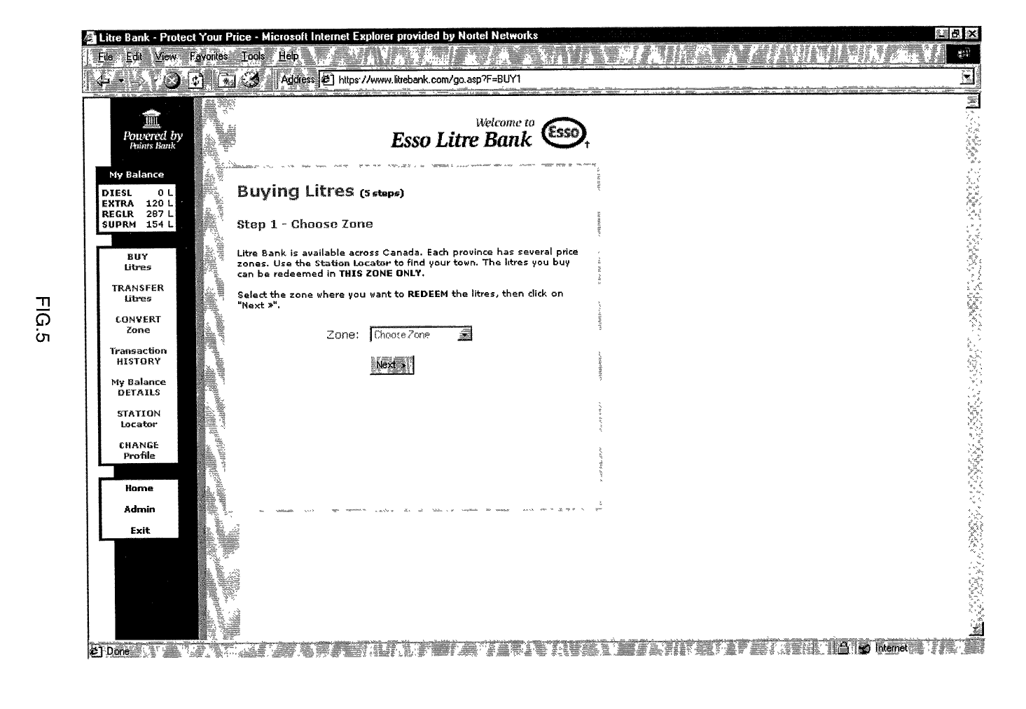

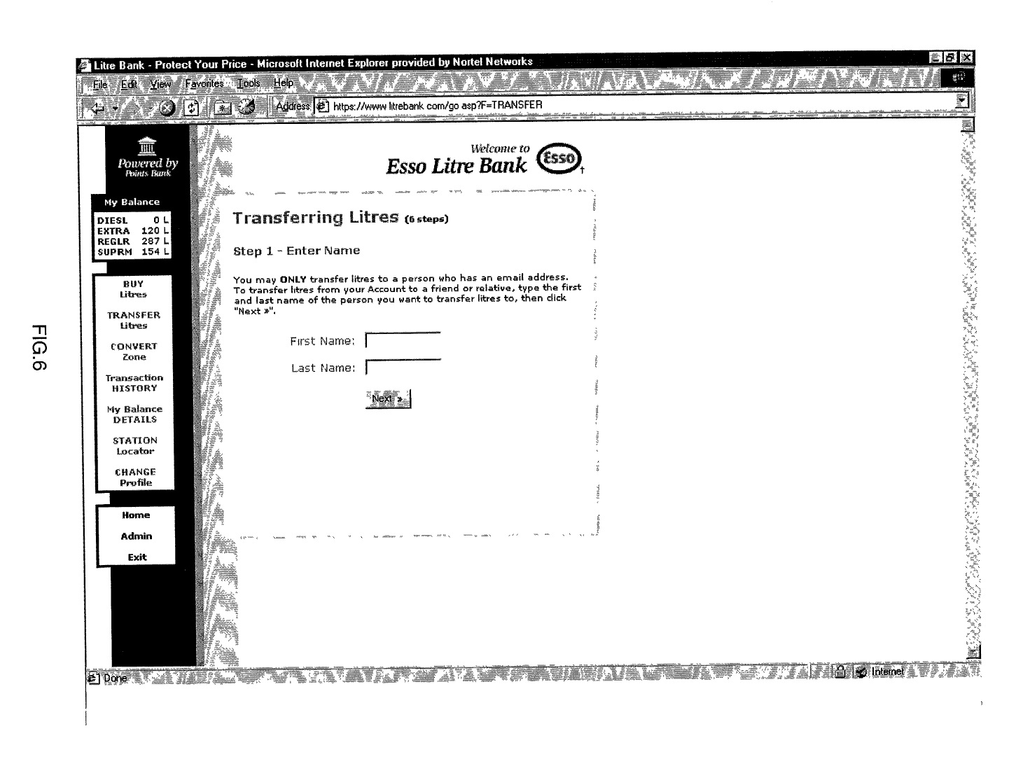

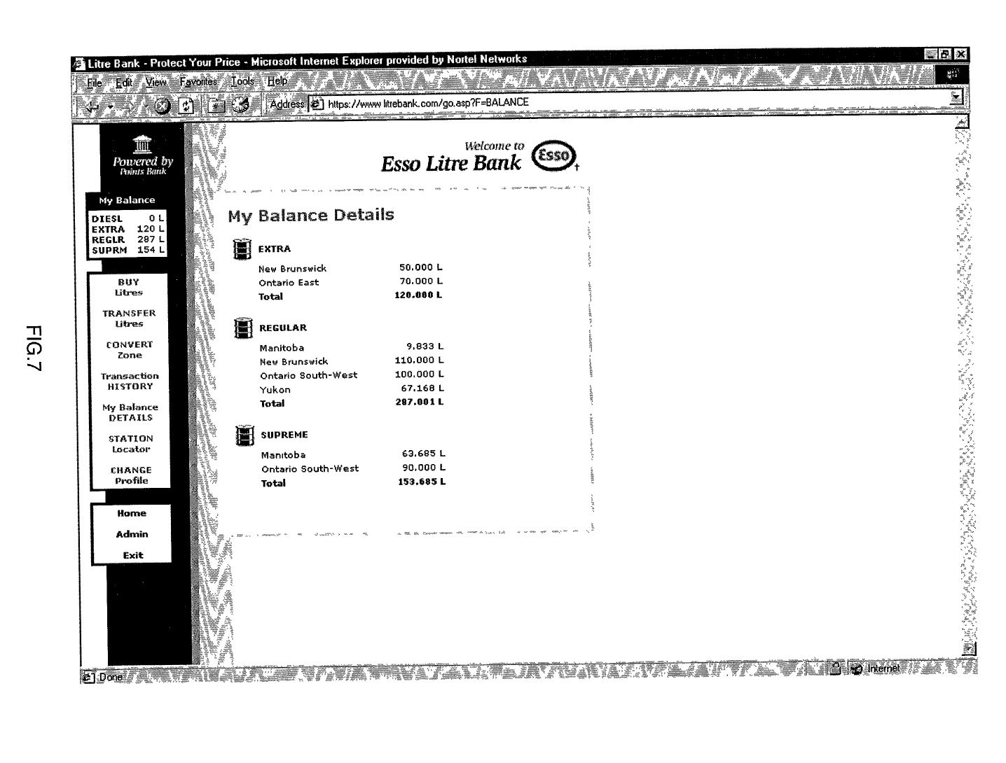

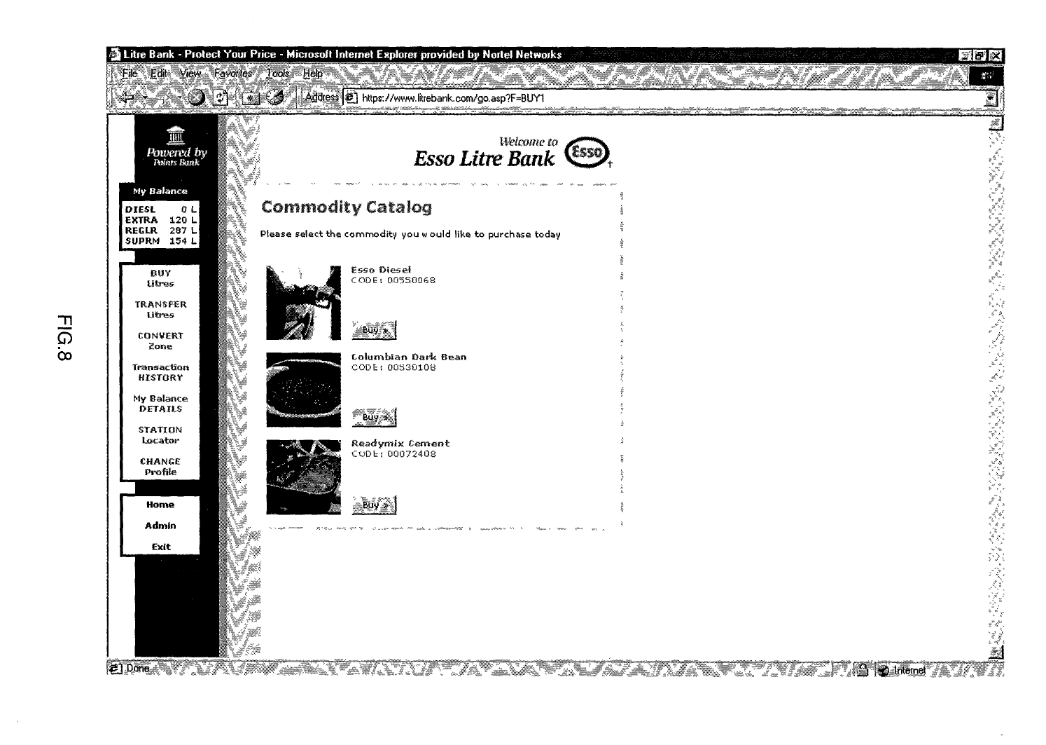

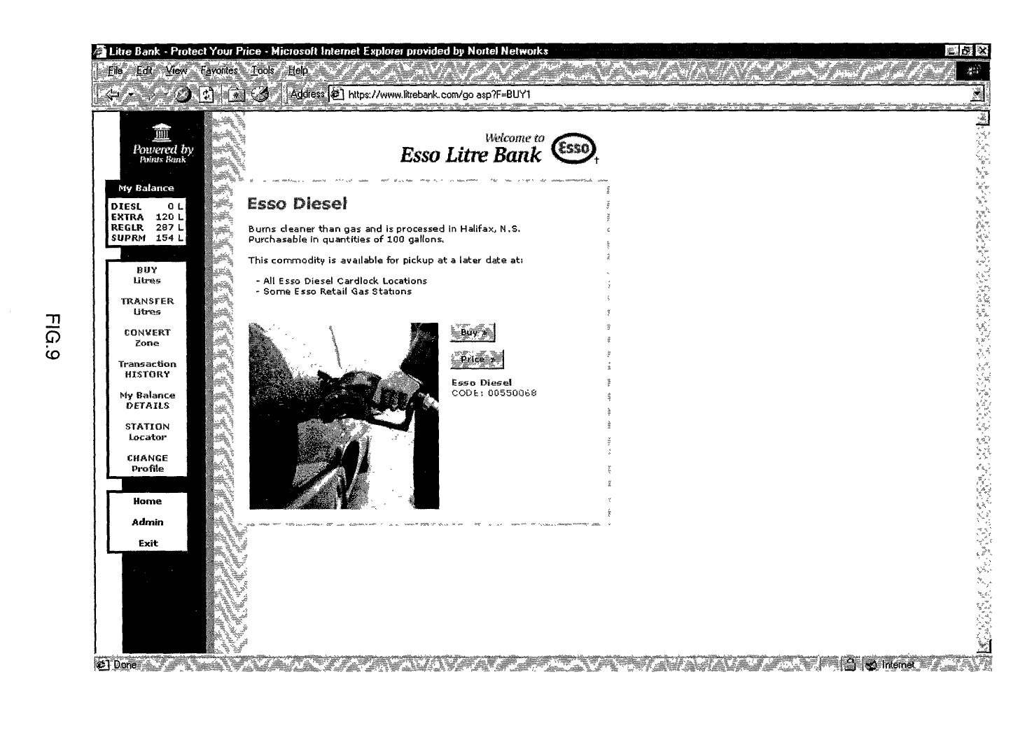

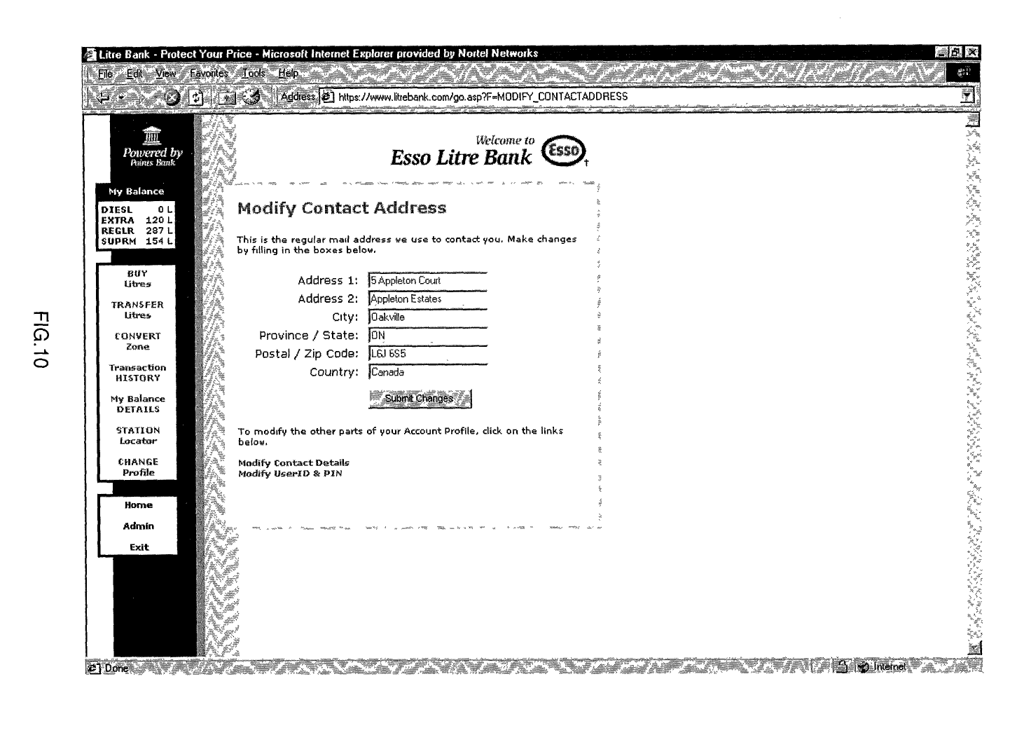

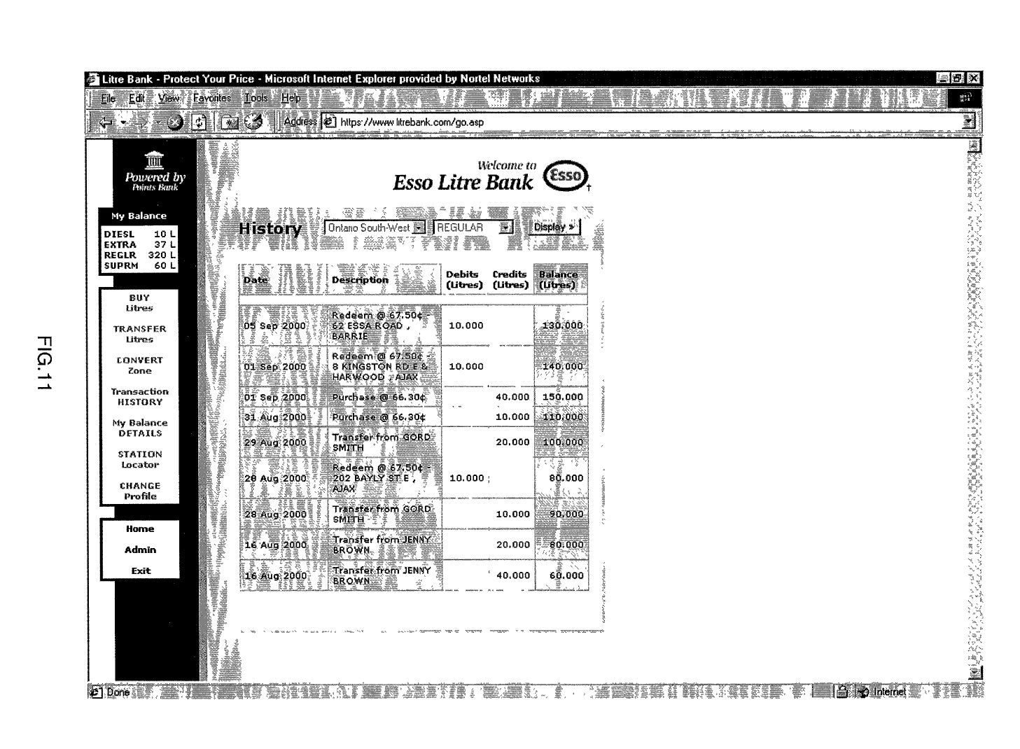

On accessing the system, users will be able to perform some or all of the following functions as shown in FIGS. 5 to 11:

Go through a step by step demonstration of how the quantity purchasing system works

Create their own account with secure User ID and password protection

Purchase discrete quantity units of commodity products using an approved payment method

Redeem discrete quantity units of the commodity within the balance available

View the on-line catalog of commodities, products and prices

Create an account for another user

Transfer quantity units of commodity to another user

View the balance of the quantity units of commodity in their account and review their transaction history

View the weighted average unit purchase value of the commodity remaining in their account so that it may be compared at any time with the current market price. (e.g. motorists will want to know if the weighted average purchase price of the pre-paid gasoline gallons remaining in their account is higher or lower than current street pump price so that they may make an informed decision whether or not to redeem)

Modify all account contact information and access codes

View and customize the system interface to reflect corporate identity

View and customize the system to intelligently reflect commodities or products available within the range of each user

In addition to the above activities, the user will be provided with general information about the electronic quantity purchasing system, system security and privacy, and a customer help line.

Although various preferred embodiments of the present invention have been described herein in detail, it will be appreciated by those skilled in the art, that variations may be made thereto without departing from the spirit of the invention or the scope of the appended claims.

What is claimed as the invention is: The embodiments of the invention in which an exclusive property or privilege is claimed are as follows:

1. A method for selling product on-line, where computer terminals of potential purchasers are used to access a computer site comprising a selling computer, said method comprising:
(A) displaying general information about each product offered for sale to identify same;
(B) displaying the current price and quantities at which the product is being offered for sale;
(C) providing each potential purchaser with an actuation control for instructing the selling computer of the decision to purchase the product at the displayed price;
(D) registering potential purchasers and obtaining and recording financial data for automated payment of purchased product;
(E) upon said purchaser operating said actuation control, and further upon receipt of said financial information, initiating a funds transfer to complete the sale and confirming purchase of the product by sending a message to the potential purchaser;
(F) storing information about the purchase in purchaser's account, including quantity of product purchased, for later dissemination to purchaser and/or entity delivering product to purchaser;
(G) deferring delivery of quantities of purchased product, in whole or in part, until such time as purchaser requests delivery;
(H) updating stored information whenever purchaser takes delivery of any portion of purchased product, or whenever additional product is purchased.

2. A method of selling on-line as claimed in claim 1, wherein step (D) can occur prior to operation of actuation control in step (E) or immediately thereafter.

3. A method of selling product on-line as claimed in claim 2, wherein said selling computer is directly connected to separate and distinct financial institutions for real time confirmation of an acceptable financial transaction of the purchase price of the product.

4. A method of selling product on-line as claimed in claim 2, wherein the product being sold can be goods or services.

5. A method of selling product on-line as claimed in claim 4, wherein the product being sold is gasoline.
